(19) United States
(12) Patent Application Publication
(10) Pub. No.: US 2015/0347508 A1
(43) Pub. Date: Dec. 3, 2015

(54) PARTIAL RESULT CLASSIFICATION

(71) Applicant: Microsoft Corporation, Redmond, WA (US)

(72) Inventors: Willis Lang, Madison, WI (US); Rimma V. Nehme, Madison, WI (US); Eric R. Robinson, Madison, WI (US); Jeffrey F. Naughton, Madison, WI (US)

(21) Appl. No.: 14/294,028

(22) Filed: Jun. 2, 2014

(51) Int. Cl. G06F 17/30

(52) U.S. Cl. CPC G06F 17/30463; G06F 17/30477

(57) ABSTRACT

A query can be executed over incomplete data and produce a partial result. Moreover, the partial result or portion thereof can be classified in accordance with a partial result taxonomy. In accordance with one aspect, the taxonomy can be defined in terms of data correctness and cardinality properties. Further, partial result analysis can be performed at various degrees of granularity. Classified partial result can be presented on a display device to allow user to view and optionally interact with the partial result.

### BACKGROUND

As the size and complexity of analytic data processing systems continue to grow, the effort required to mitigate faults and performance skew has also risen. In some environments, however, users prefer to continue query execution even in the presence of failures and receive a “partial” answer to their query. For example, a user may be doing exploratory work to gain some insight, or may be interested in answering a query that locates a thousand customers satisfying particular conditions. In such cases, it may be preferable to return imperfect answers rather than to have the query fail, incur a delay, or incur the cost and effort of ensuring that such failures do not happen.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to partial result classification. A query can be evaluated over incomplete data and produce a partial result. The partial result can subsequently be classified in accordance with a partial result taxonomy that characterizes a partial result or portion thereof, for instance in terms of cardinality and data correctness properties. Furthermore, partial result classification can be determined by way of coarse or fine grain analysis. After partial result classification or semantics are determined, they can be presented for viewing and optional interaction by way of a user interface. Additionally or alternatively, the classification can be used proactively, for example, when a user specifies he/she will tolerate solely particular kinds of anomalies.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data processing system.

FIG. 2 illustrates an exemplary query evaluation scenario.

FIG. 3 depicts a chart of partial result properties.

FIG. 4 is a block diagram of a representative classification component.

FIG. 5 illustrates representative partial result analysis models of different granularity.

FIG. 6 depicts an exemplary user interface for viewing and interacting with partial results.

FIG. 7 is a flow chart diagram of a data processing method.

FIG. 8 is a flow chart diagram of a method of analyzing a partial result.

FIG. 9 is a flow chart diagram of a method of classifying a partial result.

FIGS. 10A-B illustrate examples of aggregate operator behavior.

FIGS. 11A-B illustrate examples of aggregate operator behavior.

FIG. 12 is a schematic block diagram illustrating a suitable operating environment for aspects of the subject disclosure.

### DETAILED DESCRIPTION

Details below generally pertain to evaluation of queries over multiple information sources, some of which might return incomplete result sets. This situation can arise in a wide variety of scenarios. For example, it could arise with queries spanning a collection of loosely coupled cloud databases, if one or more of the databases is temporarily down or unusable (e.g., due to network congestion or misconfigurations). This situation can also arise with queries in a parallel database system, if a node fails during query evaluation and its data becomes unavailable, for instance. Additionally, incomplete results may be returned even with queries in a single node system, for example if some base tables or views are incomplete.

Consider a more specific example. With public clouds (e.g., AzureDB), users can sign up for multiple independent instances of relational databases. A significant number of these users choose to “self-shard,” or, in other words, horizontally partition, their tables across hundreds to thousands of these databases. In such a scenario, each of the sharded relational database systems is an independent entity, and there is no unifying system collectively managing the collection of relational systems. It is often desirable to query over the totality of these systems, but unfortunately, poor latency, connection failures, misconfigurations, or system crashes are all quite possible in any of the loosely coupled databases. At this point the law of large numbers becomes fatal—even with 99.9% uptime, a query over a 1000-shard table will likely have at least one inaccessible shard, and if executing the distributed query requires all of the 1000 systems to be accessible during execution, the query may literally never complete.

In every instance of an incomplete input, the traditional database instinct is to fix the problem by replicating data sources comprising the distributed system or making them more reliable, adding replication and failover to nodes of a database management system, or embark on data cleaning and repairing These solutions, however, can be financially costly, performance hindering, or both. Furthermore, in certain cases, such as querying over loosely coupled cloud sources, an error external to the database or misconfigurations may be impossible to fix. Finally, consistent querying techniques that rely on functional dependencies and integrity constraints currently become inapplicable in this environment. Accordingly, a different approach is taken in which queries are allowed to run to “completion” despite one or more incomplete inputs.

In some cases, of course, this is not a good idea. When reporting numbers to the Securities and Exchange Commission (SEC), billing a customer, or the like, incomplete answers are not acceptable. However, there are use cases in which a user may be willing to accept an answer computed with incomplete inputs. For example, the user may be doing exploratory work to gain some insight, or may be interested in answering a query like finding a thousand customers satisfying particular condition.

Conventionally, query processing is viewed as an incremental process in which a query processor systematically explores more and more of the input to yield successively closer approximations to the true result. By contrast, the subject disclosure is directed toward query processing in which due to forces out of the control of a query processor, part of the input is simply not available and will not become available during the query's lifetime.

Of course, merely returning such an answer to an unsuspecting user would be very poor form. Rather, the system should inform the user that a result is computed based upon incomplete data. Additionally, the more the system can guarantee about the partial result, or explain to the user about the result, the better.

In accordance with an aspect of this disclosure, a partial result taxonomy is disclosed that can be utilized to classify a partial result arising from evaluation of a query over incomplete data. By way of example, and not limitation, partial results can be characterized in terms of data correctness of either credible or non-credible as well as cardinality, such as complete, incomplete, phantom, and indeterminate, in accordance with a partial result taxonomy. Furthermore, a variety of analysis models of varying granularity can be employed to classify results. Generally, a broad classification of what can “go wrong” when evaluating queries over incomplete data is presented. This classification can be used proactively, for example, when a user specifies he/she will only tolerate particular kinds of anomalies, or after the fact in which a user is informed about anomalies that might exist in a result. In accordance with one aspect, a user can view and interact with this information, among other things, by way of a partial result user interface.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

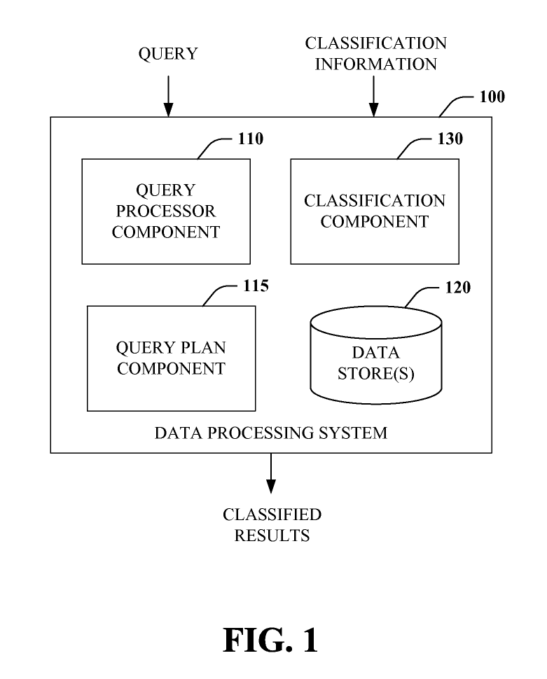

Referring initially to FIG. 1, a data processing system 100 is illustrated. The data processing system 100 is configured to receive a query and optionally classification information, and return a classified result. Accordingly, the data processing system 100 can be embodied as or form at least part of a database management system, for example. More particularly, the data processing system 100 includes query processor component 110 and query plan component 115. The query processor component 110 configured to evaluate, or in other words, execute, a query over one or more data stores 120 in accordance with a query plan determined by the query plan component 115. Although not limited thereto, in one instance, the query processor component 110 can utilize known techniques to evaluate structured query language (SQL) queries over relational data tables. The data stores 120 can be embodied as computer readable storage media and reside local or remote with respect to the query processor component 110. Moreover, herein one or more data the data stores 120 or a portion thereof can be unavailable for any number of reasons including, among others, poor latency, connection failures, misconfigurations, or system crashes. As a result, the query processor component 110 can operate over incomplete data and return a partial result.

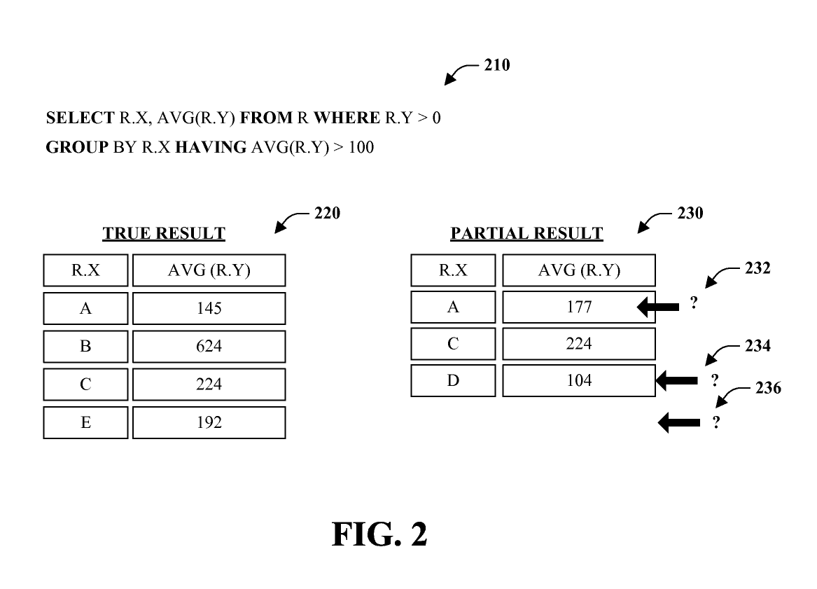

Turning briefly to FIG. 2, an exemplary scenario is depicted that demonstrates the difference between a true result and a partial result. A query 210 is illustrated that specifies a simple aggregation over a table “R.” More particularly, the query 210 indicates that an average of elements in table “R” is computed with additional filters and grouping operators. Evaluation of the query 210 over complete data produces true result 220. By contrast, evaluating the query 210 over incomplete data can produce partial result 230. Incomplete data can be produced, for instance, if a scan of the table “R” is incomplete, “R” itself is incomplete, or “R” is portioned and some partition of “R” resides on a currently inaccessible node. In this example, the result for group “C” is correct, but every other row is problematic in view of incomplete data. There are three main differences between the true result 220 and the partial result 230. First, the average value calculated for group “A” is incorrect as noted by numeral 232. Second, the tuple or result for group “D” is produced even though it is not found in the true result 220, as identified by numeral 234. Third, the partial result 230 does not produce a tuple or result for either group “B” or group “E,” noted by reference numeral 236. Each of these anomalies occurred because of incomplete data with respect to table “R.” However, these anomalies may surface at different times and for different reasons during query execution. For the first anomaly, if any data is missing it is not hard to understand why the average calculation may be wrong. For the third anomaly, the result for group “B” is perhaps missing because all the tuples or data that contribute to group “B” are missing, while the result for group “E” may be absent because data missing from the scan of “R” caused the computation of an incorrect average for group “E”, which in turned failed the “HAVING” clause filter. The second anomaly is unique because it demonstrates the results over incorrect inputs may have “extra” tuples or sets of values in their output that are not in the true result 220. Herein, these extra tuples or set of values are referred to as phantom tuples or sets of result, or more simply just phantom. Overall, this exemplary scenario provides the intuition behind classification of errors that can arise when evaluating queries over incomplete inputs.

Returning to FIG. 1, the data processing system 100 also includes classification component 130. The classification component 130 is configured to classify a partial result, which is a set of values produce from some query execution where some data needed by the query is unavailable. A failure has occurred, but query execution continues using available data. Thus, a partial result may not be the same as a true result that would have been produced had the query been able to read all data completely. Further, the classification component 130 is configured to classify a partial result based on a partial result taxonomy that captures partial result semantics, or, in other words, meaning. In this manner, a partial result can be explained or characterized to enable a user to understand how close a partial result is to a true result. An exemplary partial result taxonomy can be defined in terms of two properties, namely correctness and cardinality of a partial result.

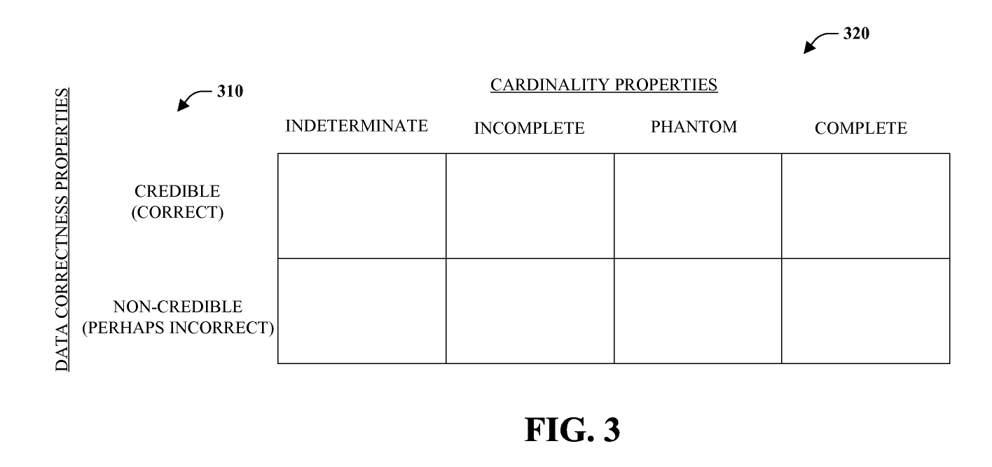

Turning attention to FIG. 3, a chart of partial result properties is depicted. As shown, cardinality and data correctness are shown on orthogonal axes. As per cardinality, four categories are proposed: indeterminate, incomplete, phantom, and complete.

Two basic aspects that characterize the cardinality of a result set relative to a corresponding true result are incomplete and phantom. If the partial result is missing tuples this is characterized as incomplete. By contrast, if a result set include extra tuples, the result set is labeled phantom.

While it may be straightforward to determine how to classify a result as incomplete, the phantom aspect or property is less clear. As an example, a phantom aspect can be produced when there is a predicate over incorrect values. This was the case with the “Having” clause described with respect to the exemplary scenario of FIG. 2. Another way phantom tuples or result sets are produced is by non-monotone operations such as “SET DIFFERENCE.” To understand this, note that for “SET DIFFERENCE A-B,” if “B” is incomplete, the result of “A-B” may have more tuples than if “B” were complete.

If an incomplete aspect of the cardinality aspect of the cardinality of a result set cannot be ruled out, and simultaneously the phantom aspect cannot be ruled out, the partial result can be characterized as indeterminate. Conversely, if both incomplete and phantom aspects can simultaneously be ruled out, the cardinality of the result is characterized as complete.

Therefore, given the presence or absence of these two cardinality aspects or properties, a result set's cardinality can be labeled complete, incomplete, phantom, or indeterminate. A partial result is complete if it can be guaranteed that each of the tuples returned correspond to a tuple of the true result. When cardinality guarantees are lost, the state of a tuple set may be escalated to another state. Escalation of a partial result or its properties means that the ability to make guarantees regarding a higher-level property has been lost, wherein complete is a higher level than incomplete and phantom, which are both at a higher level than indeterminate.

The other partial result property that is considered is correctness of data values in a result. The cardinality property is separate from the correctness property because completeness does not imply data correctness and vice versa. For example, a partial result can include a tuple set that is guaranteed to be complete even though none of the data values can be guaranteed to be correct. As a simple example, consider a “COUNT” aggregation operation without a “GROUP BY” clause. Here, the correct cardinality of one tuple will be returned, but the value may incorrect.

Data that cannot be guaranteed to be correct is classified as non-credible, while correct data is classified as credible. For simplicity herein, it is assumed that input read off a persistent data store is credible, although this need not be the case in general. This means that data can only loose the credible guarantee when it is calculated (e.g., produced by an expression) during query processing. For example, calculating a “COUNT” over a partial result that is indeterminate means that the result value may be wrong, so it is classified as non-credible.

A data set can be described with respect to credibility at different granularities. At the coarsest granularity, an entire data set can be classified as non-credible. However, sometimes the granularity can be increased. For instance, if it is known or can be determined or inferred which column of a table was produced by an expression evaluation, then some parts of the partial result can be classified as credible while others are labeled non-credible. However, the correctness property is not the only property that can be can classify a data set at different granularities. The cardinality property can be further refined for horizontal partitions of data, for example.

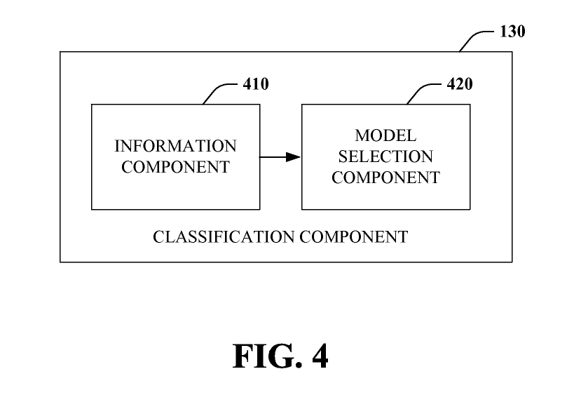

FIG. 4 is a block diagram of a representative classification component 130. Here, the classification component includes information component 410 and model selection component 420. The information component 410 is configured to acquire information pertinent to partial result classification. This information can be acquired from a user and/or determined or inferred based on context and historical processing information, for example. The model selection component 420 is configured to select a partial result analysis model from one or more available models. The partial result analysis models can differ based on the granularity at which analysis is performed. A finer granularity model will necessitate an increased understanding of a query, how data is laid out or partitioned, and/or data source availability, among other things. Accordingly, the model selection component 420 selects a partial result analysis model based on information from the information component 410. For example, the finest granularity model that is supported by the information can be selected.

One goal of classification is to provide information to help a user understand the quality of a partial result. A user can be provided with different partial result guarantees based at least on how much is known about what has failed or is inaccessible as well as the depth of query semantics or meaning considered.

Suppose that initially nothing is known about how a data set is portioned or how a query is being executed, but that some node that the system tried to access for data was unavailable. In this situation, nontrivial partial result properties cannot be guaranteed on the output. This translates to indeterminate and non-credible classification. However, if the query that was executed and the tables that were incomplete due to failures are known, more meaningful classifications or guarantees can be made.

Furthermore, if the detailed semantics of the operators applied to the query (e.g., which columns a “PROJECT” eliminates) are known or can be determined, more precise guarantees can be made and meaning provided on vertical partitions of a data set. Finally, if the identity of specific nodes that are unavailable and the horizontal partitioning strategy of a set of data are known or can be determined or inferred, subsets of tuples can be classified (horizontal partitions of the result.).

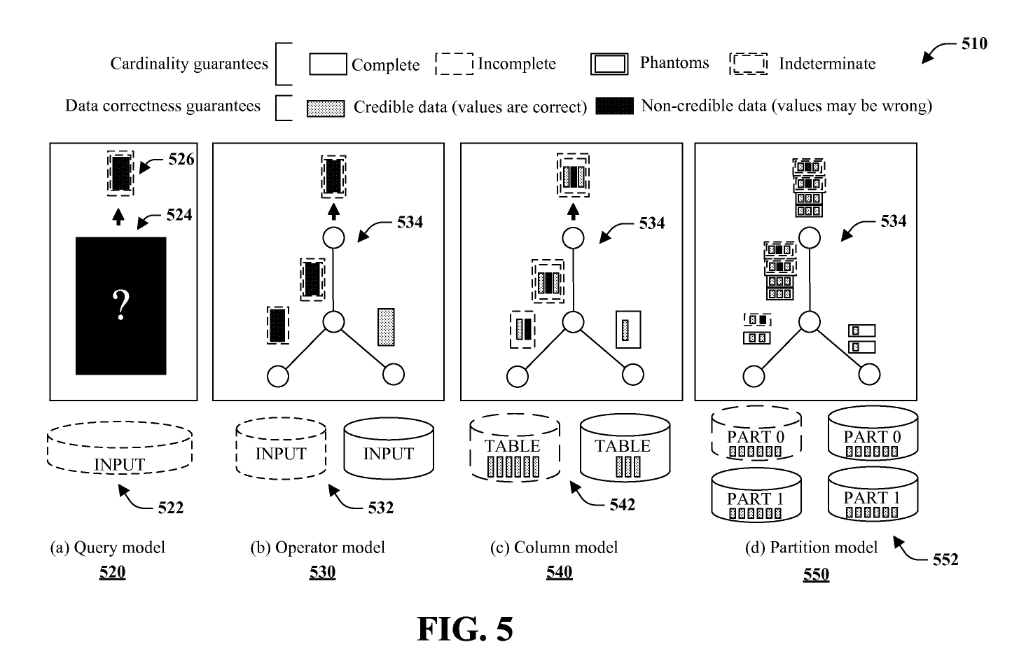

Referring to FIG. 5, four different models with different analysis granularities are shown. These four models are representative of a reasonable spectrum of models and illustrate there is a tradeoff between precision and implementation effort required and the guarantees that are possible.

For concreteness, a view creation query is over a “LINEITEM” table whose schema is shown below in TABLE 1 followed by the view definition.

TABLE 1

| column name | data type | column name | data type |
|---|---|---|---|
| L_ORDERKEY | identifier | L_RETURNFLAG | fixed text, |
| | | | size 1 |
| L_PARTKEY | identifier | L_LINESTATUS | fixed text, |
| | | | size 1 |
| L_SUPPKEY | identifier | L_SHIPDATE | date |
| L_LINENUMBER | integer | L_COMMITDATE | date |
| L_QUANTITY | decimal | L_RECEIPTDATE | date |
| L_EXTENDEDPRICE | decimal | L_SHIPINSTRUCT | fixed text, |
| | | | size 25 |
| L_DISCOUNT | decimal | L_SHIPMODE | fixed text, |
| | | | size 10 |
| L_TAX | decimal | L_COMMENT | var text, |
| | | | size 44 |

### CREATE VIEW REVENUE (SUPPLIER_NO, TOTAL_REVENUE) AS SELECT L_SUPPKEY, SUM(L_EXTENDEDPRICE×(1−L_DISCOUNT)) FROM LINEITEM

### WHERE L_SHIPDATE>=DATE ‘[DATE]’ AND L_SHIPDATE<DATE ‘[DATE]’+INTERVAL ‘3’ MONTH GROUP BY L_SUPPKEY

Consider a few queries over this view. In addition to simply scanning the view, a query variant will be considered that adds a “HAVING” clause to the “SUM AGGREGATE:”

### Q1->SELECT*FROM REVENUE

### Q3->SELECT*FROM REVENUE WHERE TOTAL_REVENUE>100000

FIG. 5 describes four different models of analysis that can be performed to determine partial result meaning when there is a table access failure. Each of the four models will be discussed starting with the coarsest analysis.

At the query model 520 granularity, a query is treated as a black box 524 that has produced a partial result 526 given that the input data 522 is incomplete. How the partial result deviates from the true result is unknown, so guarantees cannot be provided about it. Therefore, for both queries “Q1” and Q2,” the partial results that are produced are classified as indeterminate and non-credible.

The operator model 530 assumes the availability of a query and more specifically the query's logical operators. Here, it is also supposed that the query is of multiple input sources 522, such as tables, one of which is incomplete and the other complete. With this information, stronger guarantees can be provided than with the query model 520. At this granularity, for each operator in an operator tree 534, the input's partial result semantics or classifications are needed (e.g., whether it is incomplete, phantom, or credible). Then, for each operator, the semantics or classification of the output data set that it returns can be determined.

For query “Q1,” the following query plan can be identified: “PROJECT→SELECT→SUM.”

The input to the “PROJECT” operator is incomplete but credible, because the “LINEITEM” table is unable to be read in its entirety, in this example. Next, changes to partial result guarantees or classifications are determined for the queries output. Given a data set may be incomplete, but is credible, a “PROJECT” operator does not change the partial result semantics of the data set and simply produces a result labeled with the same semantics as its input, namely incomplete and credible.

Moving up the operator tree, the input to the “SELECT” is still incomplete and credible. Here, the “SELECT” operation does not change the partial result semantics since all the data is credible. Consequently, the output from the “SELECT” operation is still incomplete and credible.

Finally, the “SUM” aggregate takes as input incomplete and credible results and computes a sum using a single column for the “GROUP BY.” Given that the input is data set may be missing some data, the correct value cannot be guaranteed to be produced by the “SUM” aggregate. Furthermore, it is unknown whether all the groups of the “GROUP BY” are captured. Thus, the output of “SUM” will be labeled with incomplete and non-credible partial result semantics.

Query “Q2” performs a “SELECT” filter on the aggregated column of the (unmaterialized) view, which can be treated as a “GROUP BY . . . HAVING.” Given incomplete and non-credible input the “SELECT” escalates the partial result semantics to indeterminate, because the input values are non-credible and it is unknown whether data is correctly allowed to pass the filter or not. Therefore, the output of query “Q1” is incomplete and non-credible while the output of query “Q2” is indeterminate and non-credible.

While the operator analysis model 530 allows different partial result semantics to be distinguished, it still produces overly conservative guarantees. This is because, while it no longer treats the entire query as a black box, the operator model 530 still treats inputs and outputs as black boxes. If the columns of a data set are separated, more precise guarantees can be made about partial result semantics, which is the column model 540 of analysis.

At the operator model 530 level of analysis, the input and output data are treated as a homogeneous group of data and set the partial result semantics or classifications for all data and columns without distinction. With the column model 540 the data correctness of different parts of data are able to be discerned and tracked. To accomplish this, parameters of the operators need to be identified to know which columns of the data they are processing. The view definition of the query is now revisited to show differences between column model 540 of analysis and the prior operator model 530 analysis.

The operators in the query plan for the view are of course the same “PROJECT,” “SELECT,” and “AGGREGATE” operators considered in the operator model 530 analysis. However, each operator is now aware of the credibility of individual columns.

TABLE 2

Query plan operator order

Partial Result Credibility Semantics

| | | | | | |
|---|---|---|---|---|---|
| Q1 query plan | scan | π | σ | sum | |
| Q3 query plan | scan | π | σ | sum | σ |
| L_ORDERKEY | T | | | | |
| L_PARTKEY | T | | | | |
| L_SUPPKEY | T | T | T | T | T |
| L_LINENUMBER | T | | | | |
| L_QUANTITY | T | | | | |
| L_EXTENDEDPRICE | T | T | T | | |
| L_DISCOUNT | T | T | T | | |
| L_TAX | T | | | | |
| L_RETURNFLAG | T | | | | |
| L_LINESTATUS | T | | | | |
| L_SHIPDATE | T | T | T | | |
| L_COMMITDATE | T | | | | |
| L_RECEIPTDATE | T | | | | |
| L_SHIPINSTRUCT | T | | | | |
| L_SHIPMODE | T | | | | |
| L_COMMENT | T | | | | |
| Σ TOTAL_REVENUE | | | | F | F |

Partial Result Cardinality Semantics

| | | | | | |
|---|---|---|---|---|---|
| Incomplete | T | T | T | T | T |
| Phantom | F | F | F | F | T |

In TABLE 2 above, column credibility semantics produced by each operator is shown. As shown in TABLE 2, for query “Q1” the columns read from storage, through the “PROJECT,” and the “SELECT” are all credible. The data set is also incomplete. However, when the “SUM” aggregate is calculated over the incomplete data set, the resulting “TOTAL_REVENUE” column is determined to be non-credible. For query “Q2,” the “SELECT” predicate evaluating a non-credible column (“TOTAL_REVENUE”) results in escalation to indeterminate (both incomplete and phantom aspects cannot be ruled out).

The column model 540 of analyzing partial result semantics provides finer granularity precision for making partial result guarantees:

Q1—incomplete, credible (L_SUPPKEY) Non-credible (TOTAL_REVENUE)
Q2—indeterminate, credible(L_SUPPKEY) non-credible (TOTAL_REVENUE)

Compared to the partial result semantics produced when using the operator model 530, it is now known that certain columns of the output have correct values. For the two queries, there is a mix of credible and non-credible columns, which can be considered the hallmark of the column model 540 of analysis.

Thus far, consideration has been given to what happens when the entire input data is classified as incomplete or complete. In the partition model 550, by contrast, the input is considered a collection of partitions 552, and use properties of partitions are considered in the analysis. In large-scale parallel data processing systems, typically data is partitioned according to appropriate partitioning schemes.

Consider the example of querying over loosely coupled remote databases, where a table is “sharded” across individual shards. If it can be known or determined which nodes where unavailable or returned incomplete data, then other partitions of the table can be classified as complete and credible. This means that, if the partition properties can be propagated through the analysis of the query, certain partitions of the result can be determined to match the corresponding partitions in the true result. This is depicted in FIG. 5, where partition-level analysis breaks all of the data sets (e.g., input, intermediate, and final) horizontally into partitions. In the running example of the querying of the view, the partition model analysis will provide an even more precise classification than column model analysis.

Assume the “LINEITEM” table was partitioned across two nodes using “L_SUPPKEY” column. Call one partition “HI” and the other “LO,” where the “HI” partition has the half of the tuples with the larger “L_SUPPKEY” values. The input to queries “Q1” and “Q2” are now the two partitions of the “LINEITEM” table, where one is complete (e.g., “HI”) and the other is incomplete (e.g., “LO”).

When the initial “PROJECT” operator takes the tuples from the complete partition (“HI”) as input, it produces a complete (and still fully credible) output. On the other hand, when it processes the incomplete partition, the output analysis is the same as the column level analysis: incomplete and all columns are credible. Here, the “PROJECT” processes these two partitions and the output can be divided into two partitions because the partitioning column, “L_SUPPKEY,” was retained. Next, the “SELECT” operator processes the two partitions in the same manner as the “PROJECT.” Its output can also be thought of as two separate partitions: “HI” tuples and “LO” tuples. Again, the “SELECT” operator does not remove columns, so partitioning knowledge in “L_SUPPKEY” is retained. Finally, since the “SUM” operator performs a “Group BY” on “L_SUPPKEY,” its output tuples are also partitions into “HI” and “LO” partitions. Here, the advantages of partition level analysis can be appreciated. Since the “HI” partition was complete and all the columns were credible, the “SUM” on any of the “HI” groups is correct and can be classified as credible. This means the partial result of query “Q1” will have semantics as follows:

### Q1:

HI—{complete, credible (L_SUPPKEY, TOTAL_REVENUE)}
LO—{incomplete, credible (L_SUPPKEY) non-credible (TOTAL_REVENUE)}

Since “Q2” essentially adds a “SELECT” operator to process results of the aggregate, it will also take the “HI” and “LO” partitions as input. The partial result semantics of “Q2” is:

### Q2:

HI—{complete, credible (L_SUPPKEY, TOTAL_REVENUE)}
LO—{indeterminate, credible (L_SUPPKEY) non-credible (TOTAL_REVENUE)}

Notice that with partition level analysis, for all partial results, data that is the same as the true result can be identified and returned. The partition model for analysis provides precise guarantees in its partial result semantics by providing the finest granularity in its data classification. However, it is also the most complex.

FIG. 5 summarizes analysis for two queries based on a particular view as tighter guarantees illustrated as boxes in accordance with key 510. The partial result semantics for each query using the four levels of analysis are shown with coarsest granularity on the left and finest-granularity partition level analysis on the right. Movement from left to right indicates more of the result set can be classified as complete and credible, which provides value for a user.

Returning to FIG. 1, the data processing system 100 can operate as follows. First, the query plan component 115 choses a plan to run, which can comprise a number of operators organized as a tree, for example. The query processor component 110 can evaluate a query by executing the operators of the plan. Data accessed by these operators can be stored in multiple shards, or, in other words, horizontal partitions. If at any point during execution an input to an operator is unavailable, techniques can be used to determine and propagate errors up the query plan based on knowledge of how query operators affect classifications (e.g., data correctness, cardinality). More particularly, each query operator of the query plan passes the result of analysis to operators further up the tree, until at the root, the answer set is classified.

Since errors can be determined dynamically by the specific query plan executed, it is reasonable to question how the result classification depends upon the plan chosen. After all, a foundational principle of query evaluation in traditional settings is that the same result is computed independent of the plan, and it would be convenient if this carried over to partial result analysis so that the result classification was independent of the plan. However, this is not the case when considering failures during execution for at least two reasons, neither of which is due to analysis or propagation models.

First, consider two plans (L1)->R [symbol] S and (L2)->S [symbol] R, where the join is computed by a hash-join operator. Here “L1” and “L2” differ in that they reverse the build and probe relations of the hash join. Now suppose that it turns out that some shard storing a partition of “R” fails during the execution. The question is when. If the shard fails during a later part of the execution, it is possible that plan “L1” may not even observe this, since it may have completed its read of “R” before the failure, whereas plan “L2” might observe the failure, if it occurred during the scan of “R” at the end of the query plan.

Here, the query result itself differs depending upon which plan is chosen. This is not the fault of any design decision, it is actually reasonable in the world of unplanned failures in large distributed computations. However, it definitely means that result classification is not independent but rather dependent of the plan chosen.

This does raise a question about scenarios where the failures do not affect the final result. Is it possible that, whenever two plans give the same result in an execution possibly containing failures, the described classification scheme yields the same classification? The answer is no. Consider two physical plans “P1” and “P2” for a simple selection query on a relation sharded across multiple loosely coupled data sources. Plan “P1” scans all of the data sources in parallel applying the selection. Plan “P2” is more clever, using a global index that matches the selection predicate, and thus it is able to execute the query by only consulting the subset of shards that actually contain results to the query. The alert reader will likely see what is coming suppose that some node(s) that contains no results has failed. Plan “P1” will see the failure, but plan “P2” will not, because it does not even access the failed node(s).

Of course, this dependency on plan choice occurs even in traditional centralized systems. As a contrived example, one can imagine a situation where a table has a corrupted index, so the plans that use the index will fail while the plans that do not will succeed. What is new here is accepting partial query results and trying to classify their properties, which exposes the interaction between plans and failures.

At this point one might wonder if there are any guarantees that can be made whatsoever. It turns out that this is tied to the class of plans and failures considered. To illustrate this, first consider the case where all failures occur before the query begins executing and persist throughout the entire execution (a.k.a. persistent failure model), and second consider plans that are equivalent modulo transformations enabled by exploiting the relational algebraic property commutativity. Under these assumptions, equivalent plans yield the partial result classification.

Under the persistent failure model for different orderings (plans) of commutative operators, identical classifications of the partial result output can occur. The persistent failure assumption means that for any set of re-ordering, the (partial result) input to the operator plans will be same, and also, no failures occur in the middle of the plans.

In accordance with one aspect, the query plan component 115 can be configured to generate or select a query plan with respect to a performance based cost function. However, the query plan can be generated or selected additionally with respect to preserving partial result guarantees. Given properties of each query operator and how it may affect the quality of partial result, a plan may be selected that attempts to preserve the best guarantees with respect to a final result. Stated differently, in addition to optimizing with respect to performance, a partial result quality metric can be accounted for to produce operator trees with respect to both of these criteria.

There is also a notion of physical data layout optimization for partial results. Typically, data sources are partitioned for performance. However, given that some of the data sources are expected to be intermittently unavailable, data might be partitioned in a way that is more amenable to producing optimal partial result classifications.

Both types of optimizations can be configurable. The convention is to optimize for performance. However, a user can adjust the optimization toward performance or partial result classification, or someone between performance and classification.

Thus far, discussion has focused on analysis of queries to produce partial result classifications or guarantees in the presents of input failures. Of course, another aspect of partial results is how users can control and use a partial result-aware system along with the impact of implementing such a framework into a system.

First, discussion focuses on how users may interact with partial result aware database systems. There are two aspects of user interaction to consider, namely user input to the system, and presentation of the partial result output to users. These aspects are significant to increasing the value of partial results to a user.

A user that elects to receive partial results from a database can control how the database behaves to ultimately increase the value of a potential partial result output. For example, depending on whether or not the consumer of the result is a human or an application, the user may wish to receive any partial result or may choose to set constraints that limit the types of anomalies that are acceptable. In the former case, perhaps a human is doing exploratory, ad-hoc data analysis and is willing to accept any result anomaly. In the latter case, an application may accept solely certain partial result classifications such as Incomplete and Credible results, and otherwise return an error. In all of these cases, a user can be provided a way to signal intentions to the system, for example in the form of session controls, dynamically linked libraries (DLLS), query or table hints.

On the output side, there may be many different ways that a partial result can be presented to the user. For instance, an operator-by-operator style presentation of how partial result classifications are made can be useful to an ad-hoc, exploratory user who accepts all partial results.

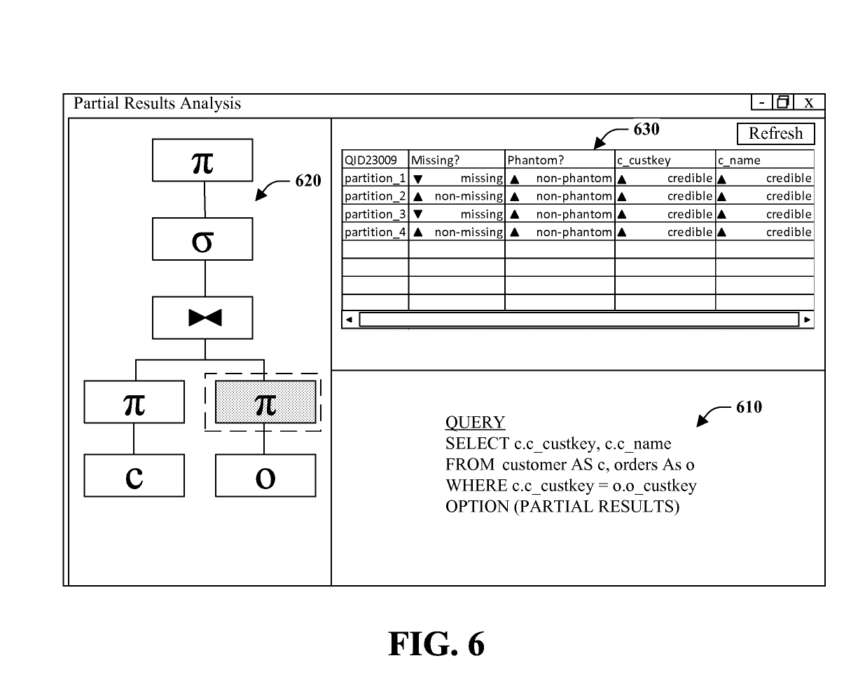

FIG. 6 illustrates an exemplary user interface that may be employed to view partial results. The interface includes three windowpanes or sections. A first section displays the query 610 that is evaluated as text. A second section displays a graphical representation of a query plan 620, or operator tree, corresponding to the query 610. A third section displays a table 630 including classifications or guarantees associated with query execution over incomplete data. Further, the interface allows not only visualization of the final classification of a partial result, but also visualization of intermediate results of each operator. For example, a user can zoom in on, or focus on, any operator of a query plan and examine the partial result guarantees made about the data at that point. Here, focus is on the “PROJECT” operator before a “CARTESIAN PRODUCT.” With this style of interface, a user may wish to receive the partial result output from any operator in the plan to maximize the value of the query's execution. Alternatively, an interface can present the actual raw data output to the user with appropriate meta-data tags. Perhaps with these interfaces, a user may even wish to “bless” the result at a given point (e.g., adjust or set a classification or guarantee) in the plan to manipulate the meta-data tags directly and gauge the effects. In other words, users can reset classifications or guarantee semantics of intermediate data as they see fit, and the final classification or guarantee of the query result set can be updated by way of propagation to reflect such changes. Of course, FIG. 6 depicts simply one of a number of possibilities for presenting partial result data and allowing user interaction. Accordingly, the subject invention is not limited to this exemplary embodiment.

Incorporating partial results analysis into an existing database management system required minimal changes to the code base, and has almost no effect on the performance of the system. When failures occur, they can be detected, which is conventionally done. However, instead of returning an error message when some data is unavailable, query execution continues, and before the final answers are returned back to the user, runtime failures can be detected and the query plan used as to its inputs to produce partial result classifications or guarantees.

FIG. 1 illustrates the classification component as embedded within the data processing system 100. However, in accordance with another embodiment, the classification component can be configured as a stand-alone component that receives results from a query execution and performance classification. This implementation, wherein failures are simply passed to a stand-alone component or system at the end also facilitates management of intermediate data access errors. Here, the inputs or outputs of certain operators can simply be retagged if some failure happened between two operators. The subject framework does not impose anything that precludes intermediate failures from being detected and applied. These guarantees along with any result data can be returned back to a user as the final answer.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the data processing system 100 can employ such mechanisms to determine or infer optimizations with respect to query plans and data layout for with respect to one or both of performance and partial result classification. Furthermore, while users can provide classification information such as how their data is laid out or the location of data with respect to data sources, such mechanisms can be employed to learn and infer the same information based on multiple query interactions with data.

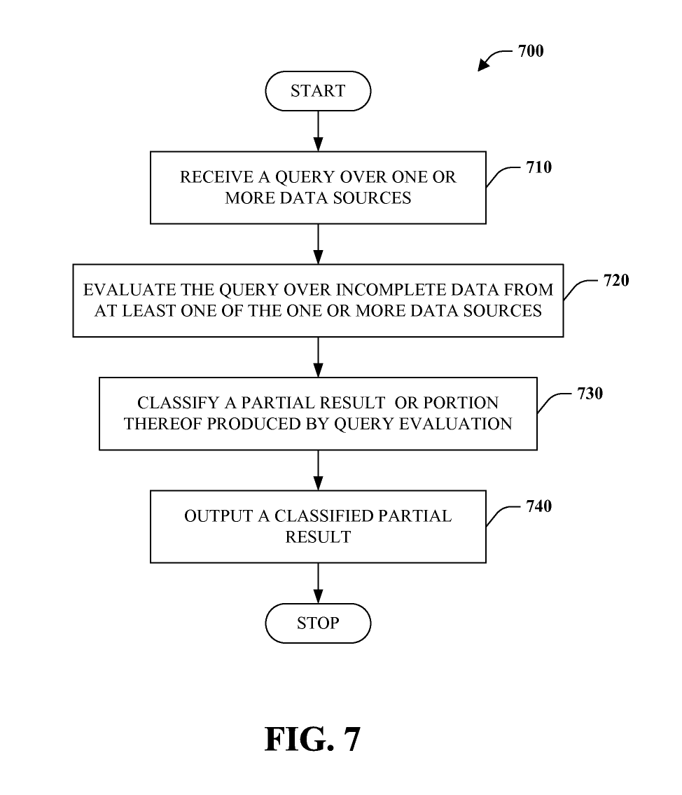

In view of the exemplary systems described above, methodologies that may be implemented in accordance with the disclosed subject matter will be better appreciated with reference to the flow charts of FIGS. 7-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, a data processing method 700 is illustrated. At reference numeral 710, query over one or more data sources is received, retrieved, or otherwise obtained or acquired. At numeral 720, the query is evaluated, or executed, over incomplete data from at least one of the one or more data sources. Incomplete data can result from poor latency, connection failures, system failures, or misconfigurations, among other things. The result of query execution is a partial result representing data produced from query execution, where some data needed by the query was unavailable. At reference numeral 730, the partial result or portion thereof is classified in accordance with a partial result taxonomy that defines various properties of partial data. For example, data can be classified as credible (e.g., correct) or non-credible (e.g., possibly incorrect) with respect to data correctness and indeterminate, incomplete, phantom or complete with respect to cardinality. Finally, the classified partial result is output, at 740, for example by way of a graphical user interface to a user for viewing and interaction.

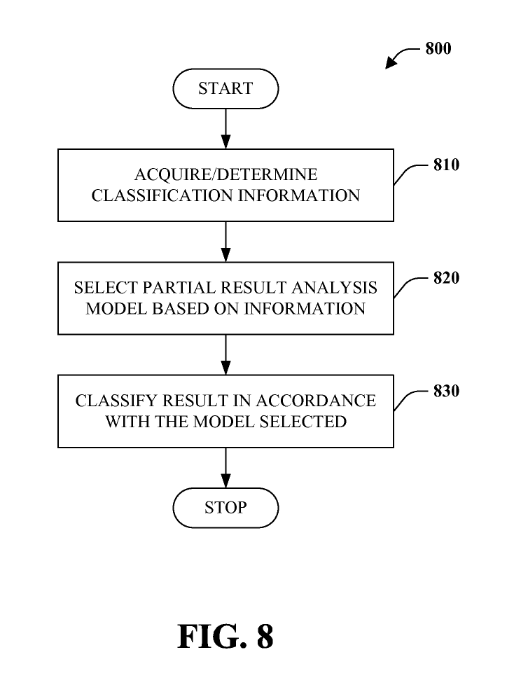

FIG. 8 depicts a method 800 of partial result analysis. At reference numeral 810, classification information is acquired or determined. Classification information includes any information regarding a query or data sources over which a query is evaluated. For instance, classification information can include a query plan, layout of data on sources, and availability of sources, among other things. Furthermore, the information can be acquired from a user or automatically or semi-automatically determined or inferred. By way of example and not limitation, based on interaction with one or more data sources in evaluating queries, the layout of data can be learned. At numeral 820, a partial result analysis model is selected based on the information. Partial result analysis models can specify analysis at varying levels of granularity. Examples of analysis models can include but are not limited to query, operator, column, and partition models, as previously described. Finer granularity analysis generally requires more information than coarser granularity analysis. Accordingly, an analysis model can be selected based on the availability and extent of classification information acquired or determined. At reference numeral 830, a partial result is classified in accordance with the selected model.

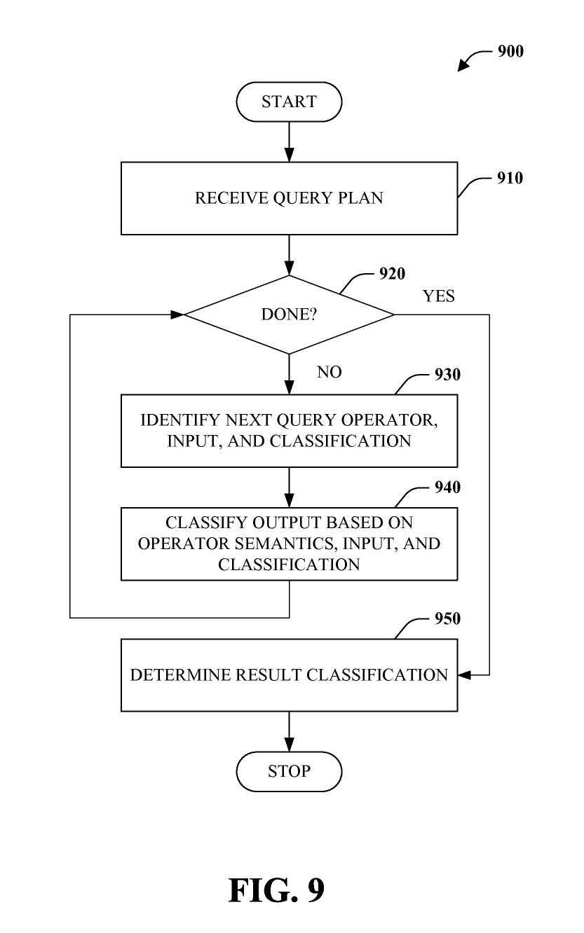

FIG. 9 is a flow chart of a partial result classification method 900. At reference numeral 910, a query plan associated with a query comprising a number of query operators is received, retrieved, or otherwise obtained or acquired. At numeral 920, a determination is made as to whether or not all operators in the query plan have been classified. If not (“NO”), the method continues at numeral 930, where the next query operator, input data, a classification are identified. For example, the query operator may be a scan, select, projection, aggregation, or grouping operator, among other relational or non-relational operators. The input data corresponds to the data operated over by the query operator. This data can include any previous classifications of the input data, for example based on output classified by a prior operator. At numeral 940, output of the query operator is classified based on the operator semantics input data and classification of the input data. By way of example and not limitation, if the query operator is a select operator, the partial result classification can be affected if the operator includes a predicate expression that operates over input data classified as non-credible. In this case, since the data values that a predicate expression is evaluated over cannot be trusted, proper elimination of data and retention of data cannot be ensured. Accordingly, the cardinality property of the result is set to indeterminate. However, if the predicate is defined over all credible data, then the partial result classification can simply propagate from input to output. Next, the method proceeds back to 920 to determine whether all classifications have been made with respect to all operators. If so (“YES”), the method continues to 950, where the final result classification is determined. In one instance, the final result classification can correspond to the output of the root node of a tree of operators.

Herein, various examples and discussion revolved around how operators of a query may change the partial result semantics of a data set as it processes the data. For purposes of clarity and thoroughness, what follows is a description of a few relational operators and their behavior with respect to partial result semantics or classification. Of course, the subject application is not limited to relational operators or the select few described below. Furthermore, the discussion will be framed in terms the way operators propagate partial result semantics using a partition model of analysis. Since, other models are essentially “rollups” of the partition model in terms of precision, the operators' behavior in those models can all be derived from the description of with respect to the partition model.

Four unary operators will be discussed first, specifically “SELECT,” “PROJECT,” “EXTENDED PROJECT,” and “AGGREGATION.” For the “SELECT” operator, the scope is to relatively simple predicate types that involve expressions (e.g., using greater than, equal, less than . . . ) on columns of tuples being processed. Projection is differentiated into two categories: those that simply remove columns (“PROJECT”), and those that can define a new column through an expression (“EXTENDED PROJECT”). FOR the “AGGREGATE” OPERATORS,” solely basic types are described, namely “COUNT,” “SUM,” “AVG,” “MIN,” and “MAX.” For each operator, how it is affected by input with certain partial result semantics and how it defines partial result semantics of the result set will be described.

The “SELECT” operator affects partial result semantics if it has a predicate that operates over columns that are non-credible. In that case, since the data values that expressions are evaluated over cannot be trusted, one cannot be confident of the elimination of tuples and the retention of tuples. In this case, the cardinality property of the result is set to indeterminate. If the predicate is defined over all credible data, the partial result semantics or classifications can simply propagate without change from the input to the output.

The “PROJECT” operator affects the partial result cardinality property of a tuple set. Cardinality can be affected when the tuple set is partitioned. For instance, the “PROJECT” operator can “taint” the semantics of a tuple set if it eliminates a partitioning column. By way of example, consider a column of a table comprising a partitioned tuple set where partition “A” is incomplete, and partition “B” is phantom. If the partitioning is eliminated by the “PROJECT” operator, then the tuple set becomes a single “partition” and one can no longer know if tuples are missing or if phantom tuples exist, thus causing the cardinality to change to indeterminate. Hence, merging tom partitions taints the result set. On the other hand, if the “PROJECT” operator removes a non-partitioning column, then “PROJECT” simply propagates the remaining rows' partial result semantics. Intuitively, in this case, the “PROJECT” operator is not affected by, nor does it affect, the credibility of columns.

The “EXTENDED PROJECT” operator can create a new column using an expression that may rely on the other columns of the tuple set, and so it is affected by input data with non-credible columns. Intuitively, if an expression computes a value using non-credible values as input, then the output is also non-credible. If the expression parameters are all credible, then this operator produces a column that can also be classified as credible. The “EXTENDED PROJECT” operator does not affect the cardinality semantics (e.g., incomplete, phantom . . . ) of a partial result.

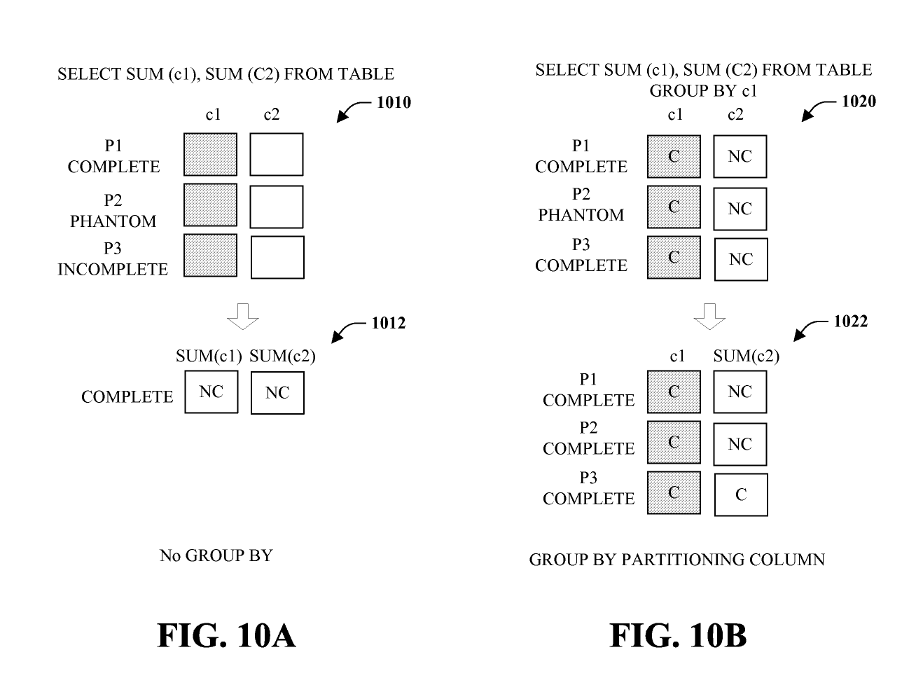

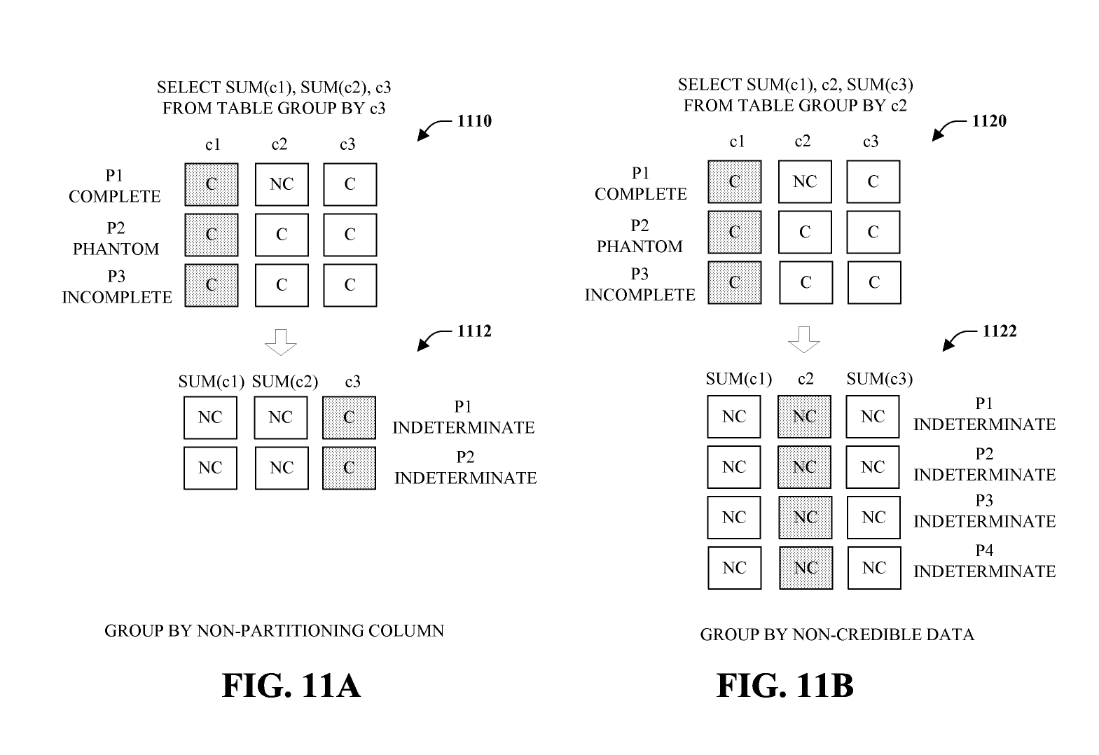

Five types of aggregate functions are considered: “COUNT,” “SUM,” “AVG,” “MIN,” AND “MAX.” To simplify discussion, solely instances where a function is applied over one column of in input set are considered. It is also assumed that there is no implicit “PROJECT” operation happening over the input that is eliminating columns. Accordingly, if five columns are provided as input, the output will also have five columns. Further, aggregate operators will be described with respect to FIGS. 10A, 10B, 11A, 11B, wherein “C” is credible, “NC” is non-credible, and the partitioning column is shaded.

Aggregation operators behave differently depending on which columns are used in a “GROUP BY” clause. An aggregation operator without any “GROUP BY” clause creates a single tuple, so the tuple will be classified as complete. Aggregate operators are distinct in that they have the ability to take a non-complete (phantom, incomplete or indeterminate) input and produce an output that is complete. However, if any of the input partitions are not complete, the results will be non-credible. FIG. 10A illustrates a table 1010 comprising columns “c1” and “c2” each segmented into three partitions “P1,” “P2,” and “P3” classified, respectively, as complete, phantom, and incomplete. Upon computing the sum of each column, the result is a single tuple 1012, which complete and non-credible.

FIG. 10B illustrates use of a “GROUP BY” clause. Here, the table 1020 comprises two columns “c1” and “c2” segmented into three partitions “P1,” “P2,” and “P3,” respectively classified complete, phantom, and complete. Here, the sum of the each of the second column “c2” is computed and a group by is performed by partitioning column “c1.” The result 1022 is a set of rows that take the partial result semantics of the source partitions. For example, if a partition has phantom semantics, the resulting tuple will have phantom semantics. Furthermore, computations performed over non-complete data results in non-credible results.

FIG. 11A shows a “GROUP BY” over a non-partitioning column that is credible. The input table 1110 comprises three columns “c1,” “c2,” and “c3” segmented into three partitions “P1,” “P2,” and “P3,” respectively classified as complete, phantom, and incomplete. When a query is executed that computes the sum of columns “c1” and “c2” and groups by the third column “c2,” the result 1112 comprises two rows grouped by column “c2.” In this case, since the input hand phantom and incomplete partitions, the output is tainted by these partitions resulting in an escalation of the cardinality to indeterminate. Further, since the aggregation operation is performed over non-complete input, the output is non-credible.

FIG. 11B illustrate an exemplary scenario in which a “GROUP BY” clause is specified over a column of data that has a non-credible value. Here, the input table 1120 includes three columns of data “c1,” “c2,” and “c3” segmented into tree partitions “P1,” “P2,” and “P3,” respectively classified as complete, phantom, and incomplete. Furthermore, partition “P1” of column “c2” includes non-credible data. After a query computes the sum of each of columns “c1” and “c3” and groups by columns “c2,” the result 1122 is a set of data that is classified a non-credible. Further, where a group by is performed with a column that has non-credible values, all the output is escalated to indeterminate. This is the only way a partitioning column becomes non-credible since there is an assumption that partitioning columns read from base tables that are deemed credible.

The binary operations considered here are “UNION ALL,” “CARTESIAN PRODUCT,” and “SET DIFFERENCE.” The “UNION ALL” operator takes sets of data and creates a new set by combining all the data. The partial result behavior of “UNION ALL” is to escalate the cardinality of the output based on the combination of the input cardinality properties. For data correctness, an output is escalated to non-credible if either of the corresponding input columns is non-credible.

As an example, consider a two tuple sets with the same partitioning strategies are given as input. The output will maintain this partitioning strategy. If the semantics of a first partition are phantom and indeterminate, the cardinality will be escalated to indeterminate. If the semantics of a second partition are incomplete and complete, the cardinality will be escalated to incomplete. If input is not partition aligned, the partitions will be lost. The result is considered a single “partition” where all of the cardinality semantics of the input partitions escalate the output.

The “CARTESIAN PRODUCT” operator is relatively straightforward in its behavior. A cross of two sets of partitions is performed to create the output. It is not affected by, nor does it change the credibility of the data values. However, the “CARTESIAN PRODUCT” may or may not simply propagate the input semantics to the output. The operator can cause partial result tainting in some cases. For instance, if all partitions of a column of data in a first set of data were classified as phantom, the “CARTESIAN PRODUCT” operator taints the cardinality semantics of the second set of data. As examples, cardinality of complete can be set to phantom and cardinality of incomplete can be set to indeterminate.

The “SET DIFFERENCE” operator is a non-monotone operator, so it can create phantom results. For example, if a second input to the “SET DIFFERENCE” operator is classified as incomplete, the output cardinality is set to phantom. Additionally, if the second input to the operator has phantom semantics, the output is tainted since data may be removed that should not have been removed. Furthermore, if the second input to the “SET DIFFERENCE” operator is includes data that is non-credible, all partitions of the result are escalated to indeterminate since the presence or absence of any data in the output cannot be trusted. If the first input has nay non-credible data, the cardinality of the result is also escalated to indeterminate.

The subject disclosure supports various products and processes that perform, or are configured to perform, various actions regarding partial result classification. What follows are several exemplary methods, systems, and computer-readable storage mediums.

A method comprises employing at least one processor configured to execute computer-executable instructions stored in memory to perform the act of classifying a partial result or portion thereof arising from evaluation of a query over incomplete data in accordance with a partial result taxonomy. The method additionally includes acts of classifying the partial result or portion thereof in terms of data correctness, cardinality, and at least one cardinality property of complete, incomplete, phantom, or indeterminate. Further, the method comprises classifying the partial result or portion thereof based on one or more query operators of a query plan of the query, identifying of one or more data sources that are unavailable to provide complete data, and a description of how data is partitioned over one or more data sources. Still further yet, the method comprises presenting on a display device the result and classification associated with the result or portion thereof and reclassifying the partial result set or portion thereof based on input from a user that adjusts a classification associated with at least one query operator output.

A system comprises a processor coupled to a memory, the processor configured to execute the following computer-executable component stored in the memory: a first component configured to evaluate a query over incomplete data and return a partial result; and a second component configured to classify the partial result or portion thereof in accordance with a partial result taxonomy. The second component is additionally configured to classify the result or portion thereof in terms of data correctness, cardinality, and at least one cardinality property of complete, incomplete, phantom, or indeterminate. Further, the second component is configured to classify the partial result or portion thereof based on one or more operators of a query plan that implements the query and identification of one or more data sources unavailable to provide complete results. Furthermore, the system includes a third component configured to render the classified partial result on a display device.

A computer-readable storage medium having instructions stored thereon that enable at least one processor to perform a method upon execution of the instructions, the method comprising classifying a partial result or portion thereof arising from evaluation of a query over incomplete data in accordance with a partial result taxonomy. The method further comprises classifying the partial result or portion thereof in terms of data correctness and at least one cardinality property of complete, incomplete, phantom, or indeterminate. Furthermore, the method comprises rendering on a display device the result and classification associated with the result or portion thereof.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

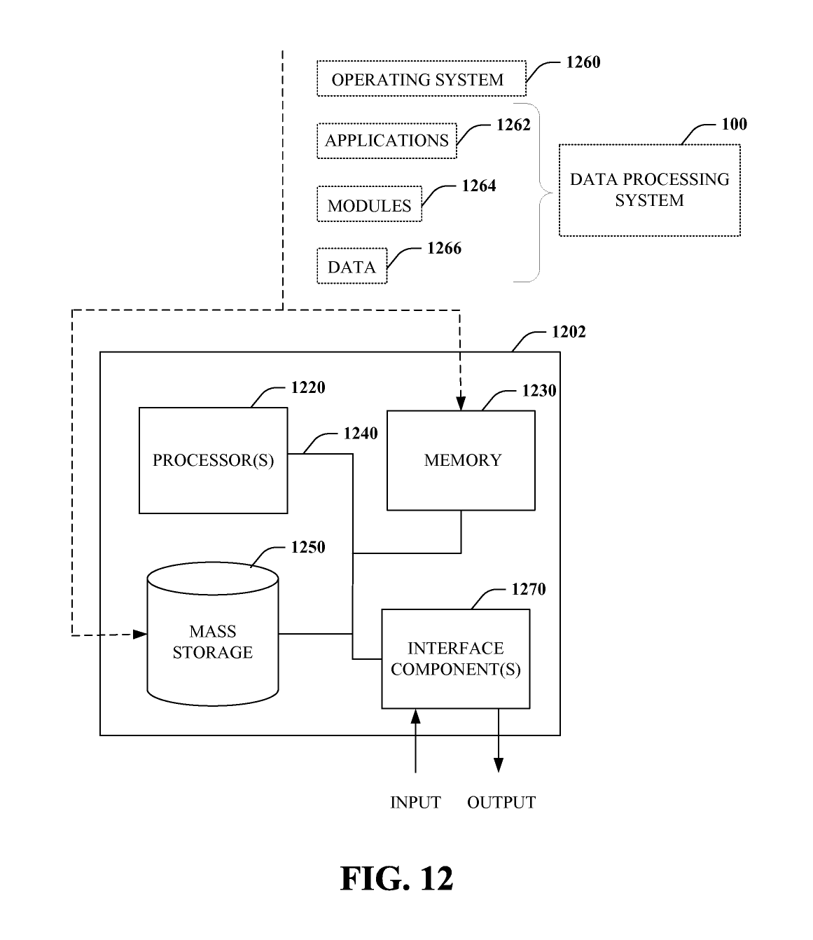

In order to provide a context for the claimed subject matter, FIG. 12 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 12, illustrated is an example general-purpose computer or computing device 1202 (e.g., desktop, laptop, tablet, server, hand-held, programmable consumer or industrial electronics, set-top box, game system, compute node . . . ). The computer 1202 includes one or more processor(s) 1220, memory 1230, system bus 1240, mass storage 1250, and one or more interface components 1270. The system bus 1240 communicatively couples at least the above system components. However, it is to be appreciated that in its simplest form the computer 1202 can include one or more processors 1220 coupled to memory 1230 that execute various computer executable actions, instructions, and or components stored in memory 1230.

The processor(s) 1220 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1220 may also be implemented as a combination of computing devices, for example a combination of a DSP and a microprocessor, a plurality of microprocessors, multi-core processors, one or more microprocessors in conjunction with a DSP core, or any other such configuration.

The computer 1202 can include or otherwise interact with a variety of computer-readable media to facilitate control of the computer 1202 to implement one or more aspects of the claimed subject matter. The computer-readable media can be any available media that can be accessed by the computer 1202 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store, as opposed to transmit, the desired information accessible by the computer 1202. Accordingly, computer storage media excludes modulated data signals or the like that merely carry data rather than store data.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1230 and mass storage 1250 (a.k.a., mass storage device) are examples of computer-readable storage media. Depending on the exact configuration and type of computing device, memory 1230 may be volatile (e.g., RAM), non-volatile (e.g., ROM, flash memory . . . ) or some combination of the two. By way of example, the basic input/output system (BIOS), including basic routines to transfer information between elements within the computer 1202, such as during start-up, can be stored in nonvolatile memory, while volatile memory can act as external cache memory to facilitate processing by the processor(s) 1220, among other things.

Mass storage 1250 includes removable/non-removable, volatile/non-volatile computer storage media for storage of large amounts of data relative to the memory 1230. For example, mass storage 1250 includes, but is not limited to, one or more devices such as a magnetic or optical disk drive, floppy disk drive, flash memory, solid-state drive, or memory stick.

Memory 1230 and mass storage 1250 can include, or have stored therein, operating system 1260, one or more applications 1262, one or more program modules 1264, and data 1266. The operating system 1260 acts to control and allocate resources of the computer 1202. Applications 1262 include one or both of system and application software and can exploit management of resources by the operating system 1260 through program modules 1264 and data 1266 stored in memory 1230 and/or mass storage 1250 to perform one or more actions. Accordingly, applications 1262 can turn a general-purpose computer 1202 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, data processing system, or portions thereof (e.g., classification component 130) can be, or form part, of an application 1262, and include one or more modules 1264 and data 1266 stored in memory and/or mass storage 1250 whose functionality can be realized when executed by one or more processor(s) 1220.

In accordance with one particular embodiment, the processor(s) 1220 can correspond to a system on a chip (SOC) or like architecture including, or in other words integrating, both hardware and software on a single integrated circuit substrate. Here, the processor(s) 1220 can include one or more processors as well as memory at least similar to processor(s) 1220 and memory 1230, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the data processing system 100 and/or associated functionality can be embedded within hardware in a SOC architecture.

The computer 1202 also includes one or more interface components 1270 that are communicatively coupled to the system bus 1240 and facilitate interaction with the computer 1202. By way of example, the interface component 1270 can be a port (e.g., serial, parallel, PCMCIA, USB, FireWire . . . ) or an interface card (e.g., sound, video . . . ) or the like. In one example implementation, the interface component 1270 can be embodied as a user input/output interface to enable a user to enter commands and information into the computer 1202, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1270 can be embodied as an output peripheral interface to supply output to displays (e.g., LCD, LED, plasma . . . ), speakers, printers, and/or other computers, among other things. Still further yet, the interface component 1270 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in memory to perform the following acts:
classifying a partial result or portion thereof arising from evaluation of a query over incomplete data in accordance with a partial result taxonomy.

2. The method of claim 1 further comprises classifying the partial result or portion thereof in terms of data correctness.

3. The method of claim 1 further comprises classifying the partial result or portion thereof in terms of cardinality.

4. The method of claim 3 further comprises classifying the partial result or portion thereof in terms of at least one cardinality property of complete, incomplete, phantom, or indeterminate.

5. The method of claim 1 further comprises classifying the partial result or portion thereof based on one or more query operators of a query plan for the query.

6. The method of claim 1 further comprises classifying the partial result or portion thereof based on identifying of one or more data sources that are unavailable to provide complete data.

7. The method of claim 1 further comprises classifying the partial result set or portion thereof based on a description of how data is partitioned over one or more data sources.

8. The method of claim 1 further comprises presenting on a display device the result and classification associated with the result or portion thereof.

9. The method of claim 1 further comprising reclassifying the partial result set or portion thereof based on input from a user that adjusts a classification associated with at least one query operator output.

10. A system, comprising:
a processor coupled to a memory, the processor configured to execute the following computer-executable component stored in the memory:
a first component configured to evaluate a query over incomplete data and return a partial result; and
a second component configured to classify the partial result or portion thereof in accordance with a partial result taxonomy.

11. The system of claim 10, the second component is further configured to classify the partial result or portion thereof in terms of data correctness.

12. The system of claim 10, the second component is further configured to classify the partial result or portion thereof in terms of cardinality.

13. The system of claim 12, the second component is further configured to classify the partial result or portion thereof in terms of at least one cardinality property of complete, incomplete, phantom, or indeterminate.

14. The system of claim 10, the second component is further configured to classify the partial result or portion thereof based on one or more operators of a query plan that implements the query.

15. The system of claim 10, the second component is further configured to classify the partial result or portion thereof based on identification of one or more data sources unavailable to provide complete results.

16. The system of claim 10 further comprises a third component configured to render the classified partial result on a display device.

17. A computer-readable storage medium having instructions stored thereon that enable at least one processor to perform a method upon execution of the instructions, the method comprising:
classifying a partial result or portion thereof arising from evaluation of a query over incomplete data in accordance with a partial result taxonomy.

18. The computer-readable storage medium of claim 17, the method further comprises classifying the partial result or portion thereof in terms of data correctness.

19. The computer-readable storage medium of claim 18, the method further comprises classifying the partial result or portion thereof in terms of at least one cardinality property of complete, incomplete, phantom, or indeterminate.

20. The computer-readable storage medium of claim 17, the method further comprises rendering on a display device the result and classification associated with the result or portion thereof.
